(19) United States
(12) Patent Application Publication
(10) Pub. No.: US 2015/0059589 A1
(43) Pub. Date: Mar. 5, 2015

(54) Automatic Puncture Mechanism of a Capsule Coffee Machine

(71) Applicant: Tsann Kuen (Zhangzhou) Enterprise Co., Ltd., Zhang Zhou (CN)

(72) Inventors: Zhiqiang Xue, Zhang Zhou (CN); Ying-I Su, Taipei City (TW); Yang-Chang Huang, Yilan City (TW); Yanming Zheng, Zhang Zhou (CN)

(73) Assignee: Tsann Kuen (Zhangzhou) Enterprise Co., Ltd.

(21) Appl. No.: 14/473,465

(22) Filed: Aug. 29, 2014

(30) Foreign Application Priority Data
Aug. 30, 2013 (CN) 201320537573.9

(51) Int. Cl. A47J 31/40

(52) U.S. Cl. CPC A47J 31/407
USPC 99/295

(57) ABSTRACT

An automatic puncture mechanism of a capsule coffee machine, which is used puncture a side wall and a top wall of a coffee capsule, including a support unit with an upper support and a lower support, a linkage unit assembled to the upper support, a first puncture unit assembled to the upper support to perforate the top wall of the coffee capsule driven by the linkage unit, a carrying base assembled to the lower support to hold the coffee capsule, and a second puncture unit assembled to the lower support to perforate the side wall of the coffee capsule driven by the linkage unit. With the linkage unit, when the upper support moves to the lower support, it drives the first puncture unit and the second puncture unit to perforate the top wall and the side wall of the coffee capsule respectively, thus making the coffee machine easier to operate.

### CROSS-REFERENCE TO RELATED APPLICATION

This application claims the benefit of priority to CN 201320537573.9, filed with the State Intellectual Property Office of the People's Republic of China on Aug. 30, 2013, the entire specification of which is hereby incorporated by reference.

### FIELD OF THE INVENTION

The present invention relates to a capsule coffee machine, especially to an automatic puncture mechanism of a capsule coffee machine.

### BACKGROUND OF THE INVENTION

We use a coffee grinder to grind coffee beans into powder to make coffee drink, then use a coffee machine to brew and filter. To make the coffee drink easier and more stable in taste, there are capsule coffee machines, firstly mixing the coffee bean to coffee material with stable taste, and then sealing up the coffee material in a capsule; this kind of capsule with coffee material is called coffee capsule. When brewing coffee, the drink-making process involves using a pricker to puncture the coffee capsule so that hot water flows into the coffee capsule, then using another pricker to puncture the coffee capsule to make the brewed coffee drink flowing out.

In traditional capsule coffee machines, to make hot water enter into the coffee capsule to brew coffee material, and to guide the coffee drink out of the coffee capsule, the coffee machine is disposed with two prickers in different movement directions and assembly positions, one pricker is used to puncture a hot water entrance in the coffee capsule, the other one is used to puncture a guiding exit in the coffee capsule, as the movement directions and the assembly positions are different, the traditional coffee machine needs two driving mechanism to drive the prickers to move respectively. Because different operations are required to operate the machine, it is easy for a user to forget to perform one of the operations.

### SUMMARY OF THE INVENTION

The object of the present invention is to provide an automatic puncture mechanism of a capsule coffee machine with improved operation convenience.

The automatic puncture mechanism of the present invention is used to perforate a side wall and a top wall of a coffee capsule, and comprises: a support unit, comprising a lower support, the lower support having a lower frame portion, an upper support pivotally connected to the lower support, the upper support comprising an upper frame portion, the upper frame portion matching to the lower frame portion when the upper support swings up and down; a linkage unit comprising a linkage handle with left and right arms, two pivot shaft components being configured to movably attach the linkage handle to the upper frame portion of the upper support, a linkage press block assembled on each of the left and right arms of the linkage handle, and at least one linkage component, each of the pivot shaft component being provided with a linkage shaft fixedly attached to the left and right arm of the linkage handle, the linkage component being provided with a gear affixed to the linkage shaft of one pivot shaft component and a moving element assembled on the upper support and engaged to the gear; a first puncture unit comprising a pricker base disposed between the left and right arms of the linkage handle, a first perforating element disposed on the pricker base to perforate the top wall of the coffee capsule; a carrying base attached to the lower frame portion of the lower support, the carrying base comparing a carry room for receiving the coffee capsule; a second puncture unit comprising a pricker frame slidably connected to the lower frame portion of the lower support and a second perforating element connected to the pricker frame, the pricker frame being driven by the moving element of the linkage component to drive the second perforating element to the carrying base in order to perforate the side wall of the coffee capsule.

The advantages of the present invention are that: with the linkage of the linkage unit, when pressing the linkage handle down, the first perforating element and the second perforating element are driven to respectively perforate the top wall and the side wall of the coffee capsule, thus simplifying and improving the operation.

### BRIEF DESCRIPTION OF THE DRAWINGS

FIG. 1 illustrates a schematic diagram of a puncture mechanism of an embodiment of the present invention, when the puncture mechanism is in an open position.

FIG. 2 illustrates another schematic diagram of the embodiment, when the puncture mechanism is in a brewing position.

FIG. 3 illustrates a partial sectional diagram of the embodiment, when the puncture mechanism is in the open position.

FIG. 4 illustrates a partial exploded and schematic diagram of the embodiment to describe the relationship of an upper support and a first puncture unit of the puncture mechanism.

FIG. 5 illustrates another partial exploded and schematic diagram of the embodiment to describe the relationship of a lower support and a second puncture unit of the puncture mechanism.

FIG. 6 illustrates a third partial exploded and schematic diagram of the embodiment to describe the relationship of a brake unit, a linkage unit and the upper support of the puncture mechanism.

FIG. 7 illustrates a side view of the embodiment when the puncture mechanism is in open position.

FIG. 8 illustrates a side view of the embodiment when the puncture mechanism is in standby position.

FIG. 9 illustrates a side view of the embodiment when the puncture mechanism is in brewing position.

### DETAILED DESCRIPTION OF THE EMBODIMENTS

The present invention will be further described with the drawings and the embodiment.

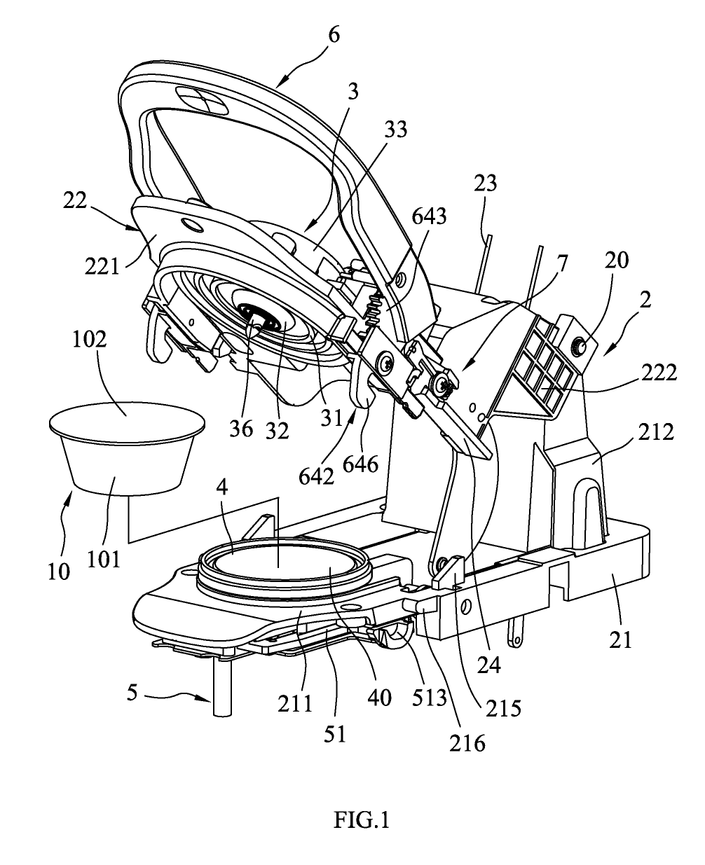

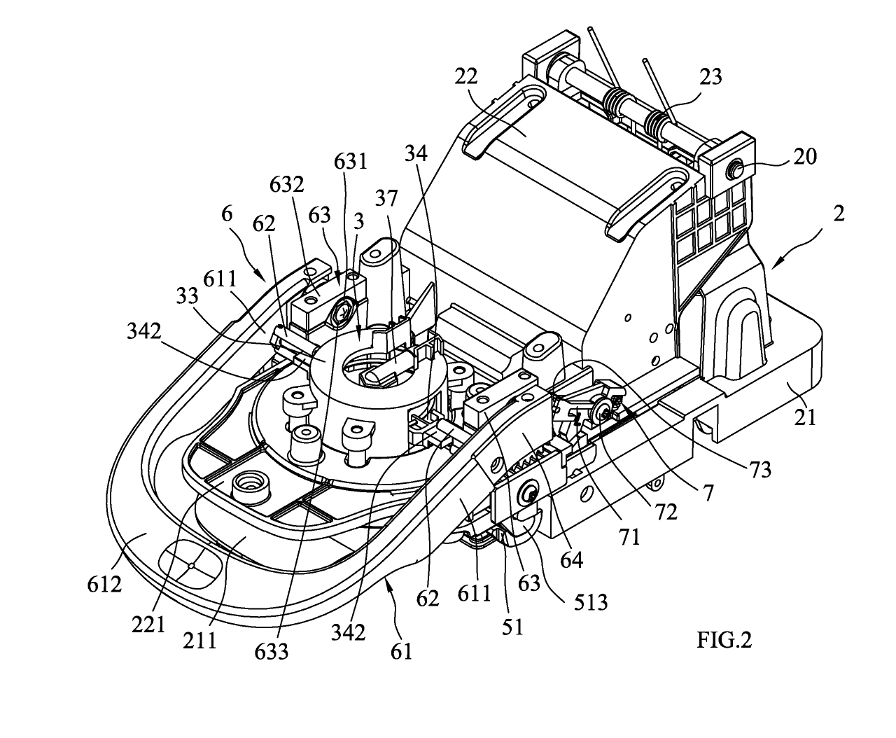

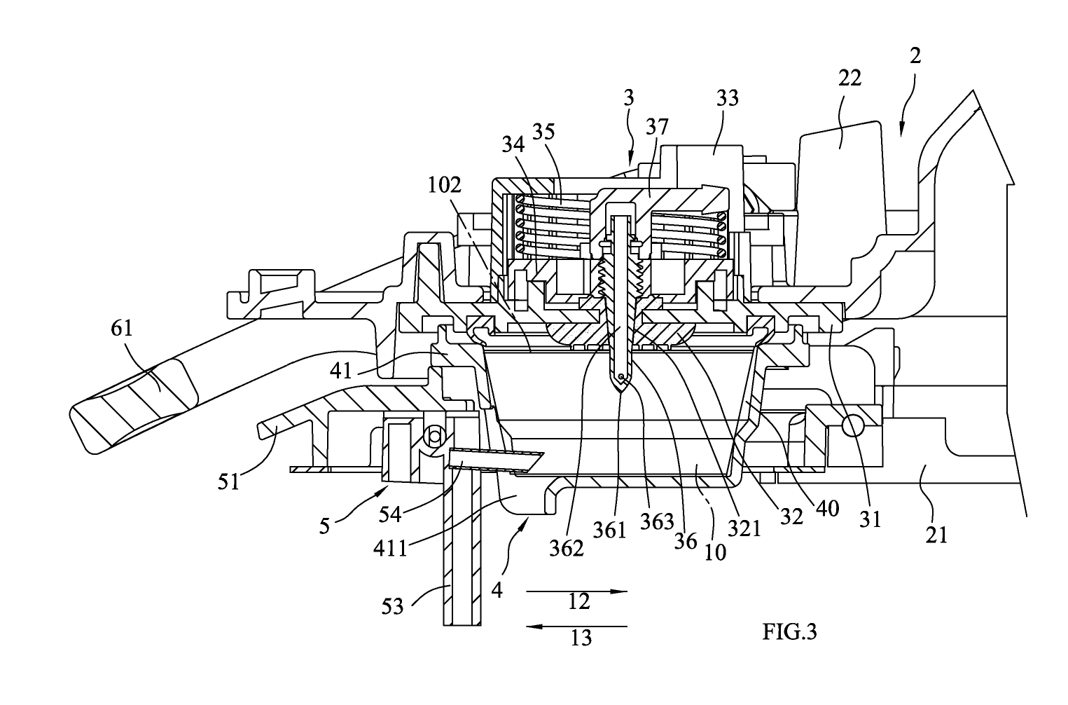

Please refer to FIG. 1, FIG. 2 and FIG. 3, an automatic puncture mechanism of the present invention can carry a coffee capsule 10 and then puncture it, the coffee capsule 10 has a round side wall 101 and a top wall 102, the puncture mechanism comprises: a support unit 2, a first puncture unit 3 configured to the support unit 2 to perforate the top wall 102 of the coffee capsule 10, a carrying unit 4 configured to the support unit 2 to carry the coffee capsule 10, a second puncture unit 5 configured to the support unit 2 to perforate the side wall 101 of the coffee capsule 10, a linkage unit 6 linked to the first puncture unit 3 and the second puncture unit 5, and left and right brake units 7 assembled to the support unit 2.

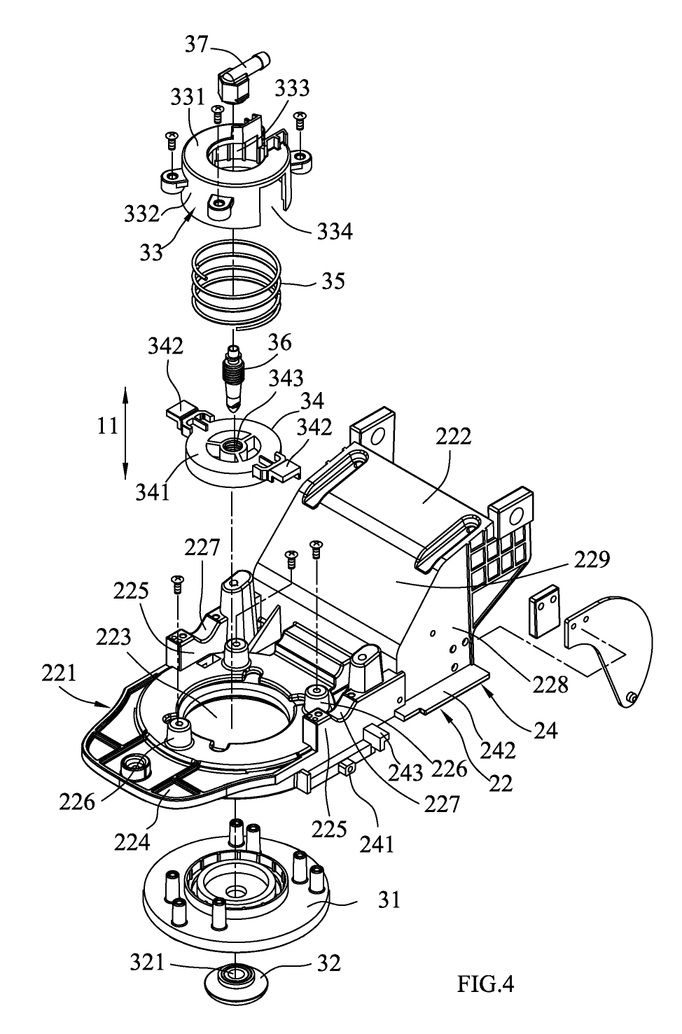

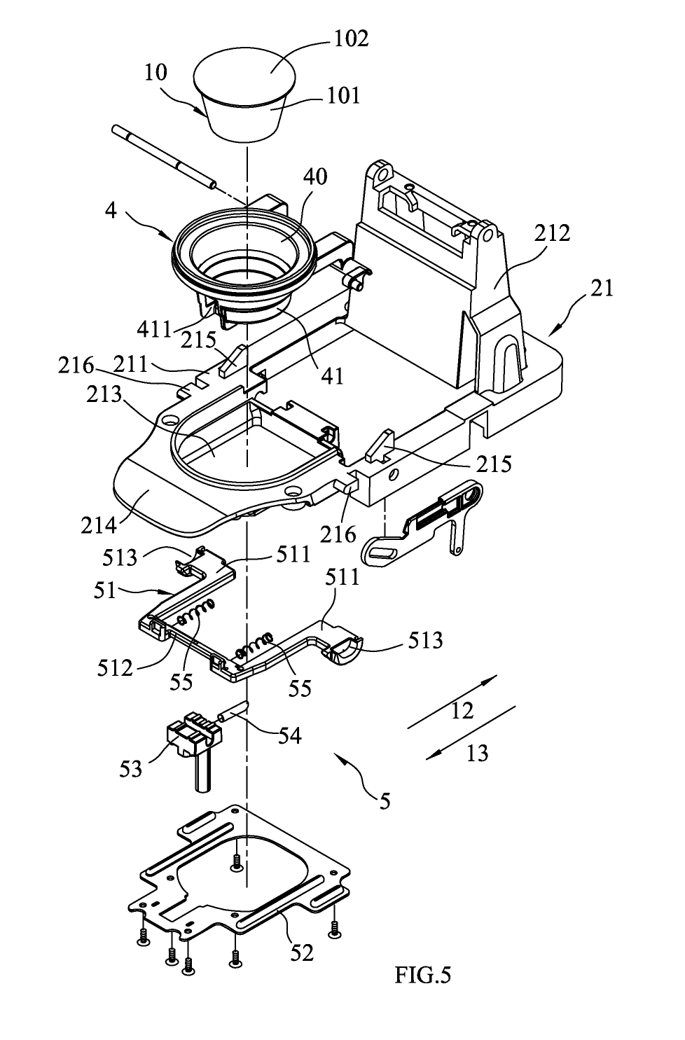

Please refer to FIG. 2, FIG. 4 and FIG. 5, the support unit 2 comprises: a lower support 21, an upper support 22 pivotably connected to the lower support 21 by a second pivot shaft 20, and a torsion spring 23 to make the upper support 22 with an upward pivoting force. The lower support 21 has a lower frame portion 211 in the front, and a lower pivot portion 212 behind the lower frame portion 211 protruded upward; the lower frame portion 211 has a lower frame wall 214 defining a vertical accommodating room 213, two protuberances 215 disposed left and right, and two hooks 216 at the opposite sides of the accommodating room 213; the hooks 216 are respectively disposed in the front of the left and right protuberances 215. The upper support 22 has an upper frame portion 221, which is in the above of the lower frame portion 211 of the lower support 21 when the upper support 22 swings, and an upper pivot portion 222 behind the upper frame portion 221 protruded up from front to back, the upper frame portion 221 has an upper frame wall 224 to define an accommodating hole 223, two protrusions 225 protruded up from the upper frame wall 224 and adjacent to the upper pivot portion 222, and a plurality of columns 226 surrounding the accommodating hole 223, each of the protrusions 225 has a frame groove 227 with opening faced up, the accommodating hole 223 is corresponding to the accommodating room 213 when the upper support 22 swings up and down, the upper pivot portion 222 has left and right side flaps 228 and a connection piece 229 connecting the left and right side flaps 228.

The upper support 22 is disposed with two assembly portions 24 of left and right symmetrical, the two assembly portions 24 cross the upper pivot portion 222 and the upper frame portion 221, each of the assembly portions 24 has a thread column 241 protruding outward laterally, a platform 242 disposed behind the thread column 241 and is configured to extend backwards, and a limited block 243 disposed between the platform 242 and the thread column 241.

The first puncture unit 3 comprises a lower fixation base 31 assembled at the lower of the upper frame wall 24 of the upper frame portion 221, a press base 32 assembled at the center of the lower fixation base 31 and is configured to press abut against on the above of the top wall 102 of the coffee capsule 10, an upper fixation base 33 fixed on the columns 226 of the upper support 22 by a plurality of screws, a pricker base 34 assembled to the interior of the upper fixation base 33 up-and-down, a first spring 35 disposed to press the pricker base 34 downwardly, a first perforating element 36 assembled to the pricker base 34 and lifted up and down along a first direction 11 elastically, and a water guiding base 37 assembled to the upper fixation base 33 to guide hot water into the first perforating element 36, the press base 32 has a lateral first through hole 321.

The upper fixation base 33 has a top side 331, a round side 332 extend from the top side 331 downwardly, and a limit room 333 surrounded by the top side 331 and the round side 332, the round side 332 has two limit grooves 334 connected to the limit room 333, the pricker base 34 has a main portion 341 disposed in the inside of the limit room 333 up-and-down, and two driven portions 342 protrude from the main portion 341 to the limit grooves 334, the main portion 341 has a second through hole 343 corresponding axially to the first through hole 321 of the press base 32. The first perforating element 36 is threaded assembled to the second through hole 343 of the pricker base 34, the top end of the first perforating element 36 is sleeved on the water guiding base 37, the first perforating element 36 has a first needle 361 with a sharp bottom, and a guiding waterway 362 connected to the water guiding base 37, the guiding waterway 362 has an outlet 363.

The carrying base 4 is disposed at the lower frame portion 211 of the lower support 21 in pivoting way, as the pivoting of the carrying base 4 is not important to the improvement of the present invention, it will not be further described hereafter. In this embodiment, the carrying base 4 comprises a round wall 41 to define a carrying room 40, the round wall 41 has a breach 411 in the front to connect to the carrying room 40, the coffee capsule 10 is placed inside the carrying room 40, the breach 411 of the carrying base 4 is corresponding to the side wall 101 of the coffee capsule 10.

The second puncture unit 5 comprises a U-shape pricker frame 51 below the lower frame wall 214 of the lower support 21, a bottom plate 52 fixed below the lower frame wall 214 by a plurality of screws to make the pricker frame 51 moved along a second direction 12, a pricker set 53 assembled to the pricker frame 51, a second perforating element 54 assembled to the pricker set 53, and a second spring 55 is configured to push the pricker frame 51 to move in a third direction 13 opposite to the second direction 12. The pricker frame 51 has left and right linkage control elements 511, and a pricker set assembly portion 512 disposed to connect between the two linkage control elements 511, the pricker set 53 is assembled to the pricker set assembly portion 512 of the pricker frame 51, each of the linkage control elements 511 has a concaved linkage groove 513 near to the rear portion. And the second perforating element 54 is designed to assemble to the pricker frame 51 directly.

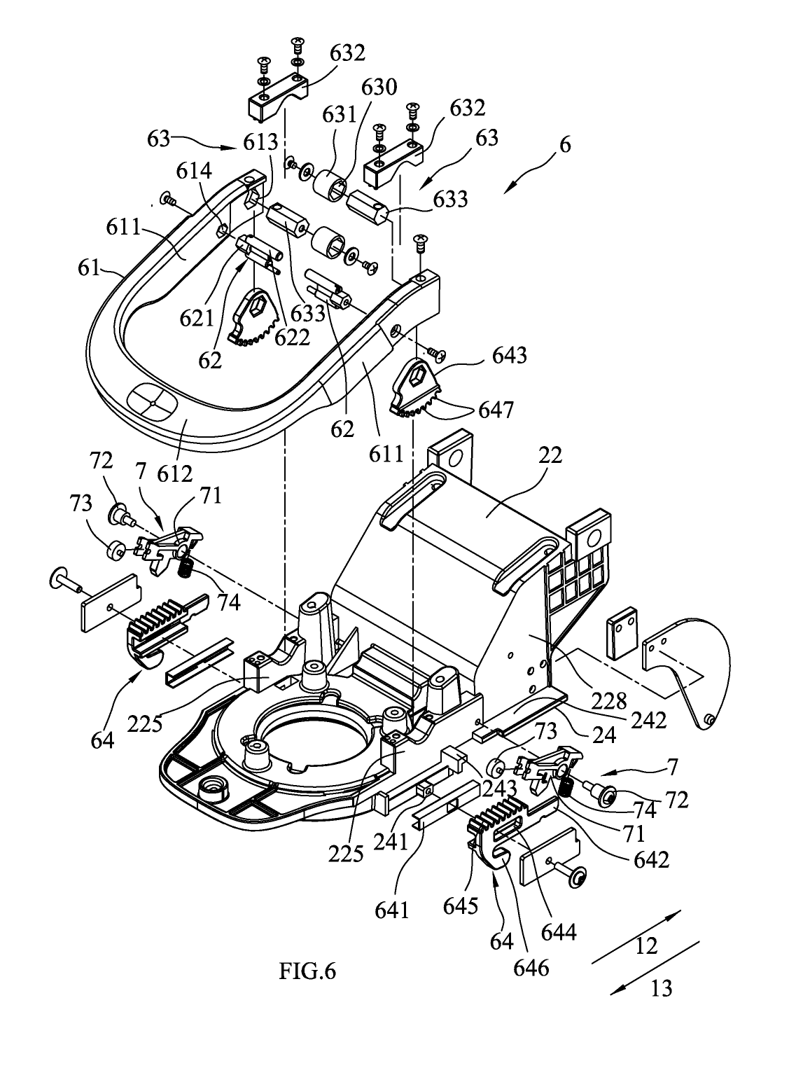

Please refer to FIG. 1, FIG. 2 and FIG. 6, in this embodiment, the linkage unit 6 comprises a linkage handle 61, two linkage press blocks 62 connected to the linkage handle 61 and the pricker base 34, two pivot shaft components 63 is configured to assemble the linkage handle 61 to the protrusions 225 of the upper support 2, and two linkage components 64 disposed spaced left and right. The linkage handle 61 comprises two left and right handle arms 611, and a handle connection portion 612 is disposed in the front of the handle arms 611 and connected to the left and right handle arms 611, each of the handle arms 611 comprises a first linkage hole 613 near to the rear portion and a second linkage hole 614 in the front of the first linkage hole 613, the cross sections of the first linkage hole 613 and the second linkage hole 614 are hexagon shaped. Each of the linkage press blocks 62 is respectively disposed with an anti-rotating insert portion 621 inserted in non-rotatable way to the second linkage hole 614 of the linkage handle 61, and a clamp portion 622 protruded from the second linkage hole 614 to clamp one of the driven portions 642 of the pricker base 34.

Each of the pivot shaft component 63 has a linkage sleeve 631, a clamp block 632 disposed to rotatably attach to the linkage sleeve 631 to one of the protrusions 225 of the upper support 22, and a linkage shaft 633 linked and sleeved to the linkage sleeve 631; the linkage sleeve 631 is disposed with a third hexagon linkage hole 630, the cross section of the linkage shaft 633 is hexagon shaped, and crossing through one of the first linkage holes 613 of the linkage handle 61 laterally and the third linkage hole 630 of the linkage sleeve 631 at the same side. That is to say, when the linkage handle 61 is pressed down, it drives the linkage sleeve 631 and the linkage shaft 633 of the pivot shaft component 63 to rotate, but the linkage sleeve 631 of the pivot shaft component 63 is rotating inside the frame groove 227 of the upper support 22.

Each of the linkage components 64 has a rail 641 assembled to the exterior of the thread column 241 of the upper support 22 by a screw, a moving element 642 movably sleeved on the rail 641, and a gear 643 linked to and assembled to the linkage end of the linkage shaft 633 of the pivot shaft component 63. The moving element 642 comprises a limit groove 644 extending along the second direction 12, a teeth bar 645 disposed above the limit groove 644, and a linkage hook 646 disposed below the limit groove 644 and is configured to insert into the linkage groove 513 of the pricker frame 51, the gear 643 has a plurality of teeth 647 to engage to the teeth of the teeth bar 645 of the moving element 642. When the gear 643 of the linkage component 64 is driven to rotate by the linkage shaft 633 of the pivot shaft component 63, it drives the engaged moving element 642 to move fore-and-back along the second direction 12 and the third direction 13.

Each of the brake units 7 of this embodiment comprises a brake frame 71, a brake pivot shaft 72 to assemble the brake frame 71 to the exterior of one side flat 228 of the upper support 21 in pivoting way, a brake wheel 73 rotatably assembled to the front of the brake frame 71, and a brake spring 74 abutting between the platform 242 of the upper support 22 and the brake frame 71, the brake spring 74 and the brake wheel 73 are in opposite sides of the brake pivot shaft 72.

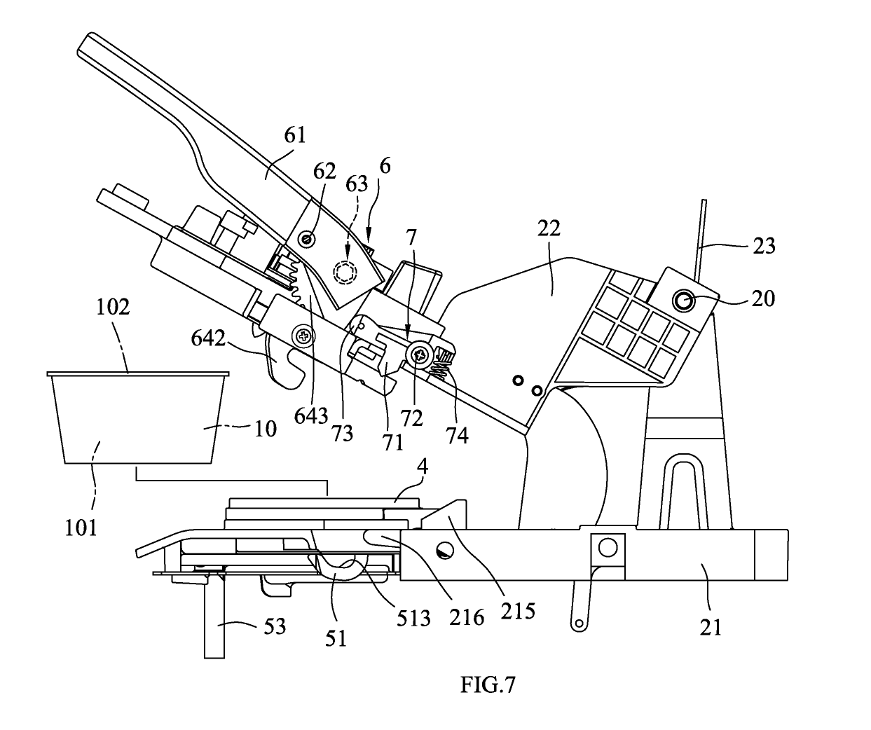

Please refer to FIG. 1, FIG. 3, FIG. 5 and FIG. 7, when the automatic puncture mechanism of this embodiment is in an open position as figured in FIG. 1 and FIG. 7, under the work of the torsion spring 23, the upper support 22 always swings upwards and backwards, the linkage handle 61 is assembled to the upper support 22, putting the coffee capsule 10 into the carrying room 40 of the carrying base 4, under the work of the second spring 55, the second perforating element 54 is placed in the front of the breach of the 411 of the carrying base 4. As the brake frame 71 of the brake unit 7 is acted upon the brake spring 74, the front end of the brake frame 71 swings downward to make the brake wheel 73 in the front press on the bottom of the side edge of the gear 643 of the linkage unit 6, in this position, the angle between the contact direction of the brake frame 71 and the contact point of the gear is 90 degrees, so that, when in the open position, the upper support 22 is braked by the brake unit 7, and thus engaged and linked to the linkage handle 61 of the linkage unit 6 so as to fix the angle between the linkage handle 61 and the upper support 22.

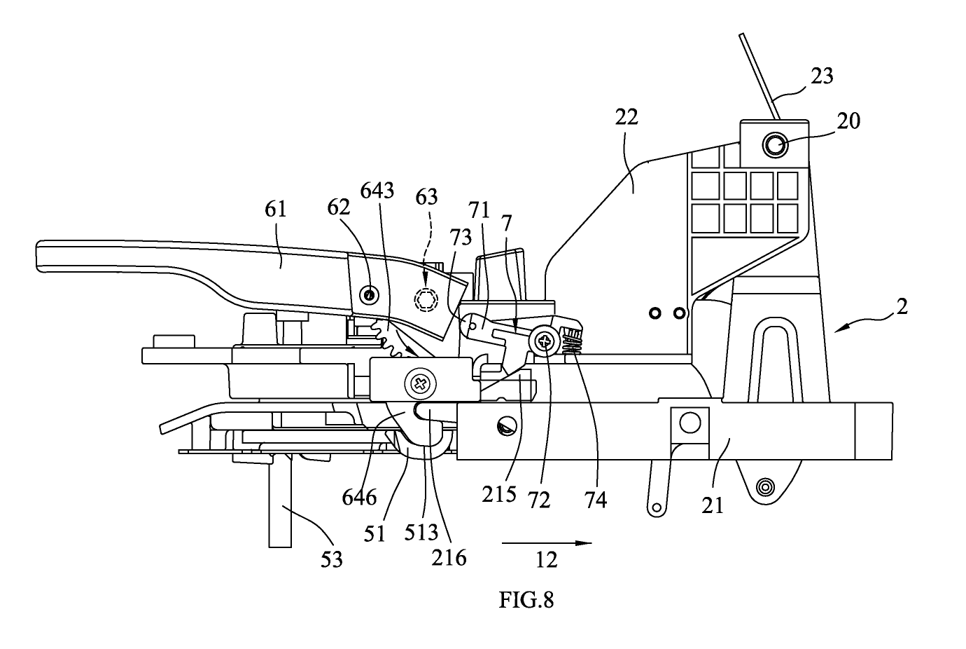

Please refer to FIG. 3, FIG. 4, FIG. 7 and FIG. 8, when the puncture mechanism of this embodiment is going to puncture a coffee capsule, handling the linkage handle 61 and pressing it down, as the brake wheels 73 of the brake unit 7 respectively abut against at the rear portion of the gear 643 of the linkage unit 6 vertically, so that, when the linkage handle 61 is pressed down, the linkage handle 61 and the upper support 22 move down in a fixed angle relationship, that is to say, at the beginning of pressing, the puncture mechanism changes to a standby position in FIG. 8 from the open position in FIG. 7, the angle between the upper support 22 and the linkage handle 61 is retained fixed. When the bottom edge of the brake frame 71 of the brake unit 7 is contacted on the top of the protuberance 215, continue pressing the linkage handle 61, the brake frame 71 are pushed and then swinging, the fixation relationship of the upper support 22 and the linkage handle 61 is no longer static, that is to say, the linkage handle 61 rotates relative to the upper support. On the other hand, the linkage hook 646 of the moving element 642 of the linkage unit 6 moves downward to fasten the hook 216 of the lower support 21, and the linkage hook 646 is inserted into the linkage groove 513 of the pricker frame 51 of the second puncture unit 5.

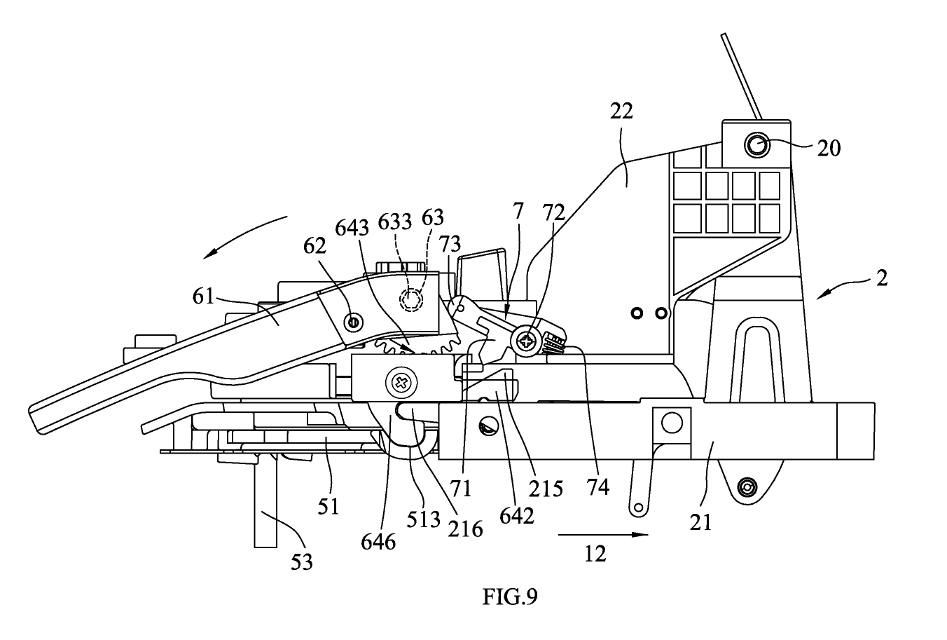

Please refer to FIG. 3, FIG. 4 and FIG. 9, when the user keeps pressing the linkage handle 61 down, the linkage handle 61 then swings about the pivot shaft components 63 relative to the upper support 22. Two linkage actions will happen during the swinging of the linkage handle 61. one action is that, the linkage press blocks 62 of the linkage unit 6 drives the pricker base 34 of the first puncture unit 3 to move down, as the first perforating element 36 is assembled to the pricker base 34, above action will drive the first perforating element 36 to move down, when the first perforating element 36 runs through the first through hole 321 of the press base 32, it punctures the top wall 102 of the coffee capsule 10, then hot water will enter into the guiding waterway 362 of the first perforating element 36 by the water guiding base 37, and then flows into the coffee capsule 10 to brew coffee.

Please refer to FIG. 3, FIG. 5, FIG. 6 and FIG. 9, the second action is that, the linkage shaft 633 and the gear 643 of the linkage unit 6 rotate synchronously, as the gear 643 of the linkage component 64 is engaged to the teeth bar 645 of the moving element 642, and the linkage hook 646 of the moving element 642 of the linkage component 64 is inserted into the linkage groove 513 of the pricker frame 51 of the second puncture unit 5, during the linkage handle 61 swings, the pricker frame 51 is also driven by the linkage unit 6 to move to the breach 411 of the carrying base 4 along the second direction 12, after the rear portion of the gear 645 of the moving element 642 of the linkage component 64 contacts the front of the limited block 243 of the assembly portion 24, the puncture mechanism changes to a brewing position in FIG. 9 from the standby position in FIG. 8. At this time, the linkage component 64 will drive the second perforating element 54 to perforate the side wall 101 of the coffee capsule 10, a coffee drink made from hot water and coffee material will flow out from the hollow second perforating element 54.

As can be seen from above, in the automatic puncture mechanism of the present invention, only if the linkage handle 61 is driven to swing, it can drive the first perforating element to perforate the top wall 102 of the coffee capsule 10 and drive the second perforating element 54 to perforate the side wall 101 of the coffee capsule, previous puncture operation only needs an action, so that it is easy to operate, and easy to remember, the present invention is definitely a new and practical automatic puncture mechanism of a capsule coffee machine.

1. An automatic puncture mechanism of a capsule coffee machine, comprising:
a support unit, comprising a lower support, the lower support having a lower frame portion, an upper support pivotally connected to the lower support, the upper support comprising an upper frame portion, the upper frame portion matching to the lower frame portion when the upper support swings up and down;
a linkage unit comprising a linkage handle with left and right arms, two pivot shaft components being configured to movably attach the linkage handle to the upper frame portion of the upper support, a linkage press block assembled on each of the left and right arms of the linkage handle, and at least one linkage component, each of the pivot shaft component being provided with a linkage shaft fixedly attached to the left and right arm of the linkage handle, the linkage component being provided with a gear affixed to the linkage shaft of one pivot shaft component and a moving element assembled on the upper support and engaged to the gear;
a first puncture unit comprising a pricker base disposed between the left and right arms of the linkage handle, a first perforating element disposed on the pricker base to perforate the top wall of the coffee capsule;
a carrying base attached to the lower frame portion of the lower support, the carrying base comparing a carry room for receiving the coffee capsule;
a second puncture unit comprising a pricker frame slidably connected to the lower frame portion of the lower support and a second perforating element connected to the pricker frame, the pricker frame being driven by the moving element of the linkage component to drive the second perforating element to the carrying base in order to perforate the side wall of the coffee capsule.

2. The automatic puncture mechanism of claim 1, wherein the linkage unit comprises a plurality of linkage components disposed on the left arm and the right arm of the linkage handle to connect to the pivot shaft components.

3. The automatic puncture mechanism of claim 2, wherein each of the left linkage handle arm and the right linkage handle arm has a first linkage hole for the linkage shaft of the pivot shaft component to be non-rotatably inserted in and a second linkage hole adjacent the first linkage hole for the linkage press block to be non-rotatably inserted in, each of the pivot shaft component of the linkage unit being disposed with a linkage sleeve to sleeve on the linkage shaft and a clamp block to rotatably assemble the linkage sleeve to the upper support.

4. The automatic puncture mechanism of claim 3, wherein each of the linkage components of the linkage unit is further disposed with a rail fixed to a side of the upper frame portion of the upper support, the moving element is movably sleeved onto the rail, a teeth bar faced to the gear and a linkage hook are further disposed on the moving element, the second puncture unit is further disposed with a pricker set configured to assemble the second perforating element onto the pricker frame, the pricker frame is disposed with left and right linkage control elements, the left and right linkage control elements are disposed with linkage grooves for the linkage hook of the moving element of the linkage component to engage.

5. The automatic puncture mechanism of claim 1, wherein the automatic puncture mechanism further comprises at least a brake unit pivotally assembled on the upper support, which is configured to fix the angle between the linkage handle and the upper support when the automatic puncture mechanism changes to a brewing position from a standby position.

6. The automatic puncture mechanism of claim 4, wherein the upper support is further disposed with an upper pivot portion and left and right assembly portions, the automatic puncture mechanism is further disposed with two brake units respectively adjacent to each of the assembly portions, each of the brake unit is disposed with a brake frame, a brake shaft pivotally attaching the brake frame to the upper pivot portion of the upper support, a brake wheel assembled to the brake frame adjacent to the gear of the linkage component, and a brake spring abutting against the brake frame to press the brake wheel against the gear of the linkage unit;
when the automatic puncture mechanism changes to a standby position from an open position, the brake unit keeps the angle between the linkage handle of the linkage unit and the upper support fixed; and
when the automatic puncture mechanism changes to a brewing position from the standby position, the angle between the linkage handle and the upper support is no longer static, and the first perforating element and the second perforating element are driven by the linkage unit to perforate the top wall and the side wall of the coffee capsule respectively.

7. The automatic puncture mechanism of claim 6, wherein the first puncture unit further comprises:
a lower fixation base assembled under the carrying base, a press base attached to the lower fixation base and having a hole for the first perforating element to axially pass through; and
an upper fixation base fixed above the pricker base, and a first spring is configured to press the pricker base down, the upper fixation base is disposed with two limit grooves respectively adjacent to the linkage press blocks of the linkage unit, the pricker base is disposed with a main portion to align the first perforating element, and two driven portions protrude from opposite sides of the main portion and extend through the limit grooves of the upper fixation base, the driven portions clamping the respective linkage press blocks of the linkage unit.

8. The automatic puncture mechanism of claim 6, wherein the second puncture unit further comprises a second spring to push the pricker frame to a direction opposite to the moving element of the linkage component.

9. The automatic puncture mechanism of claim 7, wherein the second puncture unit further disposed with a second spring to push the pricker frame to a direction opposite to the moving element of the linkage component.

10. The automatic puncture mechanism of claim 9, wherein the carrying base further comprises a round wall defining the carrying room, the round wall has a breach for the second perforating element to enter the carrying room to perforate the side wall of the coffee capsule.
